(19) United States
(12) Patent Application Publication
(10) Pub. No.: US 2004/0032586 A1
(43) Pub. Date: Feb. 19, 2004

(54) Optical transceiver, and method of manufacturing the same

(75) Inventors: Kimio Nagasaka, Nirasaki-shi (JP); Akira Miyamae, Fujimi-machi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 10/457,399

(22) Filed: Jun. 10, 2003

(30) Foreign Application Priority Data
Jun. 12, 2002 (JP) 2002-171419

(51) Int. Cl. G01J 3/28

(52) U.S. Cl. 356/328

(57) ABSTRACT

The invention provides an optical transceiver capable of simplifying the manufacturing process. An optical transceiver includes a transparent substrate having a surface emitting laser mounted thereon, a transparent substrate with a photo detector mounted thereon, a transparent substrate formed with diffraction gratings, and a transparent substrate formed with a diffraction grating adhered with each other in layers. The signal beam emitted from the surface emitting laser is introduced to the diffraction grating by the diffraction grating, converged by the diffraction grating, and introduced into the optical fiber connected to the sleeve. The signal beam emitted from the optical fiber connected to the sleeve is introduced toward the diffraction grating by the diffraction grating, converged by the diffraction grating, and introduced into the photo detector.

### BACKGROUND OF THE INVENTION

1. Field of Invention

The present invention relates to an optical transceiver used for communication using opticals, and a method of manufacturing the optical transceiver.

2. Description of Related Art

Optical communication that establishes communication using a beam as a carrier can provide high-speed and high-capacity communication. An arterial network or a subscriber loop system network can be established to take advantage of such characteristics at home and abroad. The standard of the network connecting subscribers (users at home, etc.) and a station is internationally standardized as ITU-T Recommendations G.983.1, and the related art includes a plan to employ a wavelength division multiplexing system (WDM system) that transmits and receives information using an optical fiber and two wavelengths of 1.3 μm band and 1.55 μm band.

In the wavelength division multiplexing system, optical signals of 1.55 μm in wavelength can be used to transmit from the station to the subscriber, and optical signals of 1.3 μm in wavelength can be used to transmit from the subscriber to the station. The terminal of the subscriber for optical communication (for example, a personal computer) is provided with an optical transceiver as an interface for transmission and reception of optical signals. The optical transceiver includes elements, such as a light emitting element to convert electrical signals carrying transmitting information, which is to be transmitted to the station, into optical signals, a light receiving element to convert optical signals transmitted from the station into electrical signals, and a connecting element (optical connector) to connect the optical fiber connected to the station and the unit including the light emitting element and the light receiving element.

### SUMMARY OF THE INVENTION

In providing the optical communication network as described above, it is important to reduce the cost of the optical transceiver provided on the subscriber's terminal. However, in the optical transceiver of the related art, a method, such as anisotropic etching, is employed when machining roughness on the silicon substrate, on which components, such as an optical element or a three-dimensional optical wave guide are mounted, a long machining time is required. In addition, since components, such as an optical element, are mounted at different positions on the silicon substrate while performing accurate positioning three-dimensionally, the number of processes required for mounting increases. Thus, manufacture of the related art optical transceiver requires various processes and high manufacturing costs.

In view of the above and/or other circumstances, the present invention provides an optical transceiver that enables simplification of the manufacturing process.

The present invention also provides a method of manufacturing an optical transceiver that enables simplification of the manufacturing process.

In order to address or achieve the objects described above, an optical transceiver according to the present invention includes a spectroscopic unit, a light emitter, and a light receiver, which are disposed at one end of an optical path to propagate signal beam in both directions and disposed respectively on a surface substantially orthogonal to the optical axis of the signal beam emitted from one end of the optical signal path. The spectroscopic unit changes the direction of the signal beam emitted from one end of the optical path and introduces the same toward the light receiver, and the spectroscopic unit introduces an optical emitted from the light emitter to one end of the optical path.

Another optical transceiver of the present invention includes a spectroscopic unit, a light emitter, and a light receiver, which are disposed at one end of an optical path to propagate a plurality of signal beams having different wavelengths in both directions and are disposed respectively on a surface substantially orthogonal to the optical axis of the signal beam emitted from one end of the optical signal path. The spectroscopic unit receives the signal beam emitted from one end of the optical path as an incoming beam, converts the direction of the optical axis of the incoming beam corresponding to the wavelength thereof, and introduces the incoming beam toward the light receiver, and the spectroscopic unit introduces the signal beam emitted from the light emitter to one end of the optical path.

Since the elements including the spectroscopic unit, the light emitter, and the light receiver are disposed on a surface orthogonal to the optical axis of the signal beam emitted from one end of the optical path, simplification of the construction, facilitation of alignment are achieved, and simplification of the manufacturing process of the optical transceiver is achieved. As a consequence, the manufacturing cost can be reduced, and hence the lower cost of the optical transceiver is achieved.

Preferably, the spectroscopic unit, the light emitter, and the light receiver are located at different orthogonal planes, respectively.

Preferably, the spectroscopic unit, the light emitter, and the light receiver are supported by transparent substrates (or light translucent substrates), respectively. Accordingly, an optical system can be constructed by aligning the transparent substrates, which support the spectroscopic unit, the light emitter, and the light receiver, respectively, into layers. Therefore, manufacture of the optical transceiver is facilitated, and thus the lower cost is achieved. A manufacturing method including: providing a plurality of transparent substrates, providing a plurality of spectroscopic units, a plurality of light emitters, and a plurality of light receivers on the respective transparent substrates respectively; stacking the transparent substrates one on another, and then dividing the stacked layer later, can be employed. Therefore, a plurality of optical transceivers can be manufactured effectively. Particularly, when such a manufacturing method is employed, highly accurate alignment among the spectroscopic unit, the light emitter, and the light receiver can be achieved at once for a plurality of optical transceivers, and thus the manufacturing process can be significantly simplified.

Preferably, the aforementioned spectroscopic unit is realized by an wavelength-output angle transformational circuit to vary the angle of the optical axis of the emitting beam corresponding to the wavelength of the incident beam, including a diffraction grating. Accordingly, the thickness of the spectroscopic unit can be reduced.

Preferably, a thickness d of the grating is set to a value satisfying the expression λ1/(n−1)<d<λ2/(n−1), where d represents the thickness of aforementioned diffraction grating, n represents an index of refraction of the material of the diffraction grating, λ1 represents the smaller one of the wavelengths of the transmitting beam and incoming beam, and λ2 represents the larger one of them. As a consequence, both of the transmitting beam and the incoming beam can obtain high diffraction efficiency.

Preferably, the diffraction grating as a spectroscopic unit also has a collective function. Accordingly, the signal beam can be guided into the optical path efficiently. The spectroscopic unit may be realized by a prism.

Preferably, a first deflecting unit to convert the direction of the signal beam emitted from the light emitter, and guiding it to the spectroscopic unit is further provided. Accordingly, flexibility of arrangement of the light emitter increases and thus layout design is facilitated.

Preferably, the first deflecting unit is realized by the wavelength-output angle transformational circuit to vary the angle of the optical axis of the emitting beam corresponding to the wavelength of the incident beam, including the diffraction grating. Accordingly, the thickness of the first deflecting unit may be decreased.

Preferably, the first deflecting unit is disposed on a surface, which is substantially parallel with a plane on which the spectroscopic unit is disposed.

Preferably, the first deflecting unit is supported by the transparent substrate. Accordingly, the optical system can be constructed by aligning the transparent substrate, which support the spectroscopic unit described above, and a transparent substrate, which supports the first deflecting unit, into layers. Therefore, the construction can be simplified, and the manufacturing process can be prevented from becoming complex due to provision of the first deflecting unit or such complexity can be reduced.

Preferably, a second deflecting unit to convert the direction of the signal beam emitted from the spectroscopic unit, and introduce it to the light receiver is further provided. Accordingly, flexibility of the arrangement of the light emitter increases, and thus layout design is facilitated.

Preferably, the second deflecting unit is realized by the wavelength-output angle transformational circuit to vary the angle of the optical axis of the emitting beam corresponding to the wavelength of the incident beam, including the diffracting grating and the lens. Accordingly, the thickness of the second deflecting unit can be reduced.

Preferably, the second deflecting unit further includes a collective function. Accordingly, since the signal beam outgoing from the spectroscopic unit can be converged and guided into the optical path, the reception of information is further reliably preformed.

Preferably, the second deflecting unit is disposed on a surface, which is substantially parallel with the surface on which the spectroscopic unit is disposed.

Preferably, the second deflecting unit is supported by the transparent substrate. Accordingly, the optical system can be constructed by aligning the transparent substrate, which support the spectroscopic unit described above, and a transparent substrate, which supports the second deflecting unit, into layers. Therefore, the construction can be simplified, and the manufacturing process can be prevented from becoming complex due to provision of the second deflecting unit or such complexity can be reduced.

Preferably, the first and the second deflecting units are arranged on the same plane. Therefore, when supporting the first and the second deflecting units by the transparent substrate, both of them can be supported on the same transparent substrate, and thus the construction can be simplified by reduction of the number of components. In this case, since assembly of the first and the second deflecting units can be performed simultaneously, reduction of the cost by simplification of the manufacturing process is achieved.

Preferably, the second deflecting unit is a reflecting type diffraction grating, which reflects the signal beam emitted from the spectroscopic unit, and introduces it to the light receiver. Therefore, the light receiver can be arranged at the position farther from the light emitter, and thus the cross-talk (radio interference) between them can be effectively prevented or reduced.

Preferably, a light conversing unit to guide a signal beam emitted from one end of the optical path to the spectroscopic unit is further provided as a substantially parallel ray. Consequently, the signal beam can be guided into the optical path more efficiently. The light conversing unit is preferably realized by a lens.

Preferably, a cross-talk preventing unit disposed between the light emitter and the light receiver to prevent or reduce leakage of signals therefrom is further provided. Consequently, even when the light receiver is disposed at the position relatively close to the light emitter, the cross-talk between them can be prevented or reduced.

Preferably, the spectroscopic unit and the cross-talk preventing unit are disposed on a surface orthogonal to the optical axis of a beam outgoing from one end of the optical signal path.

Preferably, the spectroscopic unit and the cross-talk preventing unit are supported by the transparent substrates, respectively. Consequently, the optical system can be constructed by aligning the transparent substrate, which supports the spectroscopic unit described above, and the transparent substrate, which supports the spectroscopic unit and the cross-talk preventing unit, into layers, and thus the construction is simple and the manufacturing process can be prevented from becoming complex or such complexity can be reduced.

Preferably, the cross-talk preventing unit is a conductive film formed on the transparent substrate. Therefore, the cross-talk preventing unit has not only a function of light shielding but also a function of electromagnetic shielding between two signal beams, so that leakage of electric signals between the transmitting/receiving circuits is prevented or reduced. In addition, the cross-talk preventing unit can be disposed in a small space.

The present invention also provides a method of manufacturing an optical transceiver apparatus including a light emitter, a light receiver, and a spectroscopic unit to change the direction of the optical axis of a emitting beam corresponding to the wavelength of an incident beam, the optical transceiver apparatus being arranged at one end of the optical signal path, which is used to propagate a plurality of signal beams having different wavelengths in both directions, to transmit and receive information. The method includes: assembling a first transparent substrate formed with a plurality of spectroscopic units, a second transparent substrate formed with a plurality of light receivers, and a third transparent substrate formed with a plurality of light emitters; and cutting the assembled first to third transparent substrates into a plurality of sub-substrates, each including one of the light receiver, the light emitter, and the spectroscopic unit.

According to the manufacturing method described above, since a number of spectroscopic units (such as diffraction gratings) can be formed simultaneously on a single transparent substrate, the efficiency of the manufacturing process can be enhanced. In addition, since the first transparent substrate having a number of spectroscopic units formed thereon, the second transparent substrate having a number of light receivers formed thereon, and the third transparent substrate having a number of light emitters formed thereon are assembled in layers, and then divided into segments, accurate alignment is made when assembling the transparent substrates in layers, and thus a plurality of optical transceivers can be manufactured at once without performing alignment individually for each optical transceiver. As a consequence, the manufacturing process can be simplified, and thus the manufacturing costs are significantly reduced.

Preferably, the spectroscopic units to be formed on the first transparent substrate are realized by the diffraction gratings. Preferably, the process of assembling the substrates is performed by adhering the substrates with each other.

### BRIEF DESCRIPTION OF THE DRAWINGS

FIG. 1 is a schematic showing a structure of an optical transceiver according to the first exemplary embodiment;

FIG. 2 is a schematic illustrating a detailed example of a construction of a diffraction grating;

FIG. 3 is a schematic illustrating a detailed example of a construction of the diffraction grating;

FIGS. 4(a) and 4(b) are schematics illustrating an example of a method of manufacturing the optical transceiver;

FIG. 5 is a schematic illustrating a structure of an optical transceiver according to the second exemplary embodiment;

FIG. 6 is a schematic that shows a construction of an optical transceiver employing a lens-integrated sleeve;

FIG. 7 is a schematic showing a construction of an optical transceiver according to the third exemplary embodiment;

FIG. 8 is a schematic showing a construction of an optical transceiver according to the fourth exemplary embodiment;

FIG. 9 is a schematic showing a construction of an optical transceiver according to the fifth exemplary embodiment;

FIG. 10 is a schematic showing a construction of an optical transceiver according to the sixth exemplary embodiment.

### DETAILED DESCRIPTION OF PREFERRED EMBODIMENTS

An exemplary embodiment of an optical transceiver to which the present invention is applied is described below with reference to the drawings.

(First Exemplary Embodiment)

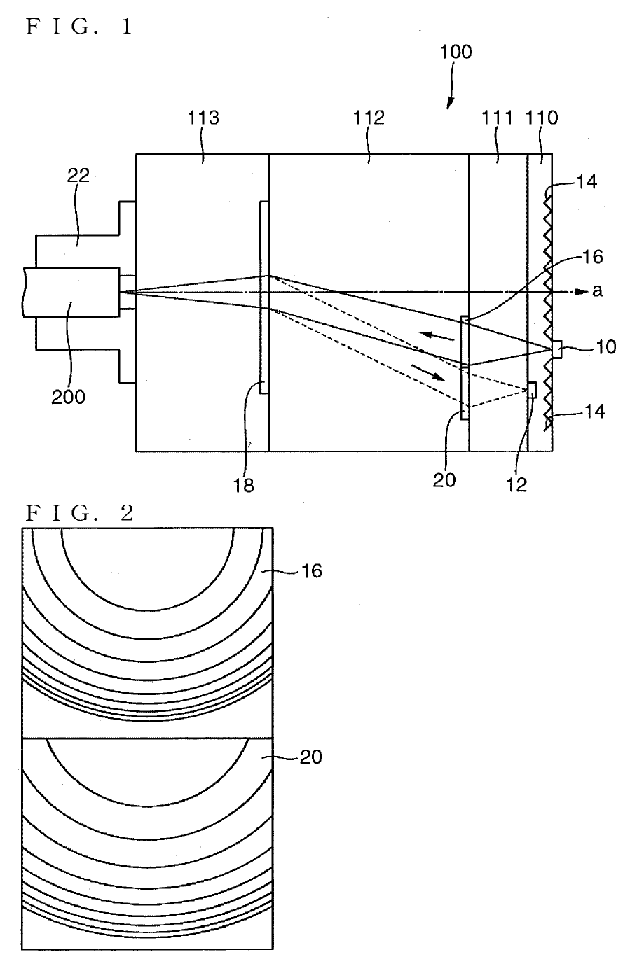

FIG. 1 is a schematic showing a construction of an optical transceiver according to the first exemplary embodiment. An optical transceiver 100 shown in FIG. 1 is used for communication via an optical fiber 200 through which signal beams are propagated in both directions, and includes a surface emitting laser 10, a photo detector 12, a metallic film 14, three diffraction gratings 16, 18, 20, a sleeve 22, and transparent substrates 110, 111, 112, 113 to support these elements. The transparent substrates 110-113 each are made of a plate-shaped member formed of substantially transparent resin or glass, and, as shown in FIG. 1, are disposed on a surface, which is substantially orthogonal to the optical axis a of the signal beam emitted from the optical fiber 200.

The surface emitting laser 10 is a light emitter emitting a laser beam of 1,3 μm in wavelength used for transmission of information, and is mounted on the transparent substrate 110 at a predetermined position on one side.

The photo detector 12 is a light receiver to convert an optical into an electric signal, and is disposed on the substrate 111 at a predetermined position on one side. A recess is formed on the transparent substrate 110 at the position being in abutment with the photo detector 12, and the transparent substrate 110 and the transparent substrate 111 are adhered with each other with the photo detector 12 fitted into the recess formed on the transparent substrate 110.

The metallic film 14 is disposed between the surface emitting laser 10 and the photo detector 12 to prevent or reduce a cross-talk between the surface emitting laser 10 and the photo detector 12. According to the present exemplary embodiment, the metallic film 14 is formed by forming a metallic thin film on the surface of the transparent substrate 110 on the side where the surface emitting laser 10 is provided. The metallic film 14 serves as an electromagnetic shielding film by being connected to a predetermined reference potential point (not shown). The metallic film 14 also serves as a light shielding film. In this manner, since the surface emitting laser 10 and the photo detector 12 are mounted on the different substrates, and the metallic film 14 is provided between them to block or substantially block a noise caused by an electromagnetic wave or the like, a cross-talk between the transmitting unit including the surface emitting laser 10 and the receiving unit including the photo detector 12 may be prevented from occurring or can be reduced.

The diffraction grating 16 is formed on one side of the transparent substrate 112, and converts a laser beam (signal beam) emitted from the surface emitting laser 10 into a beam (a bundle of rays) that can be regarded as a substantially parallel ray, and changes the direction of the main beam into the direction toward the diffraction grating 18. The diffraction grating 16 is arranged in a surface, which is substantially orthogonal to the optical axis “a” of the signal beam emitted from the optical fiber 200. The surface emitting laser 10 is disposed so that the main beam of the emitted laser beam is impinged substantially orthogonally to the surface in which the diffraction grating 16 is disposed. As a consequence, the laser beam emitted from the surface emitting laser 10 can be guided into the diffraction grating 16 efficiently, and thus loss of the signal light can be minimized or reduced.

The diffraction grating 18 is formed on one side of the transparent substrate 113, and the direction of the main beam of the incident beam coming from the diffraction grating 16 is changed toward an opening of the sleeve 22 and focused thereon, so that the beam is introduced into the optical fiber 200 connected to the sleeve 22.

The sleeve 22 is a terminal to which one end of the optical fiber 200 is connected. The beam emitted from the diffraction grating 18 enters into the core of the optical fiber 200 connected to the sleeve 22. The sleeve 22 is disposed in such a manner that the direction of the main beam coming from the diffraction grating 18 enters into the optical fiber 200 so as to be substantially orthogonal to the end surface of the optical fiber 200. As a consequence, the beam emitted from the diffraction grating 18 can be guided into the optical fiber 200 efficiently, and thus loss of the signal beam can be minimized or reduced.

The diffraction grating 18 converts the signal beam having a wavelength of 1.55 μm emitted from the optical fiber 200 connected to the sleeve 22 into a beam that can be regarded as a substantially parallel ray, and changes the direction of the main beam into the direction toward the diffraction grating 20.

The diffraction grating 20 is formed on one side (on the same side on which the diffraction grating 16 is formed) of the transparent substrate 112, and converges the beam emitted from the diffraction grating 18, changes the direction of the main beam into the direction toward the photo detector 12, and enters the converged beam into the photo detector 12.

The diffraction grating 18 and the transparent substrates 112, 113 described above correspond to the aforementioned wavelength-output angle transformational circuit as a spectroscopic unit.

The diffraction gratings 16, 18, 20 are described in detail below.

FIG. 2 is a schematic showing detailed examples of the constructions of the diffraction gratings 16, 20. As described above, the diffraction gratings 16, 20 are formed on one side of the identical transparent substrate 112, and FIG. 2 front views of the diffraction gratings 16, 20.

As shown in FIG. 2, the diffraction gratings 16, 20 are formed so that the equiphase lines extend arcuately. The pattern of the equiphase lines can be obtained by obtaining the diffraction angle by tracking the respective beams based on the optical system shown in FIG. 1 and then calculating distribution of the phases based on the calculated diffraction angle. The distance between the beam emitted from the diffraction grating 16 and the beam impinged onto the diffraction grating 20 is determined by the wavelengths of the respective beams (1.3 μm and 1.55 μm in this exemplary embodiment), the intervals of grating of the diffraction grating 18, and the distance between the diffraction gratings 16, 20 and the diffraction grating 18. The distance of the beams is determined by considering the dimensional limit of the entire optical transceiver 100.

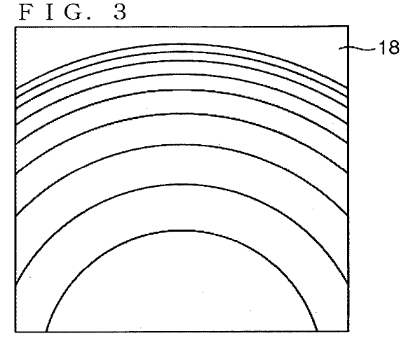

FIG. 3 is a schematic illustrating a detailed example of the construction of the diffraction grating 18. FIG. 3 is a front view of the diffraction grating 18. As shown in FIG. 3, the diffraction grating 18 is formed in such a manner that the equiphase lines extend arcuately. The pattern of the equiphase lines can be obtained in the same manner described in conjunction with the diffraction gratings 16, 18.

A depth “d” of the grating of the diffraction grating 18 preferably satisfies the expression shown below:

λ1/(n−1)<d<λ2/(n−1) (1)

where: n represents a refractive index of the substantially transparent material forming the diffraction grating, λ1 (μm) represents a smaller wavelength of two wavelengths of signal beams used for communication, and λ2 (μm) represents the larger wavelength of the same.

In the present exemplary embodiment, a beam having a wavelength of 1.3 μm is used for transmission, and a beam having a wavelength of 1.55 μm is used for reception. Therefore, the expression (1) is expressed as follows:

1.3/(n−1)<d<1.55/(n−1) (2)

A high efficiency of diffraction is obtained both for transmission and reception by setting the depth “d” of the grating of the diffraction grating 18 so as to have the relation as shown above. Since the efficiency of diffraction depends on the depth of the grating, the intensity of light required for the optical systems for transmission and reception can be obtained by adjusting the value of the depth d of the grating accordingly.

The method of forming the diffraction gratings 16, 18, 20 is described below. A substrate formed of substantially transparent material, such as quartz glass or the like, is provided, and photo-resist is applied on the substrate. Subsequently, the aforementioned arcuate pattern is transferred to the photo-resist using a laser drawing device, an electronic beam drawing device, or the like. Then, etching is performed with the photo-resist being used as a mask, so that the diffraction grating is formed. It is also possible to fabricate a metal die using the diffraction grating formed in such a manner, and form a diffraction grating based on the fabricated metal die by injection molding or 2P (photo-polymer) method. These methods have an advantage in that they are suitable for commercial production.

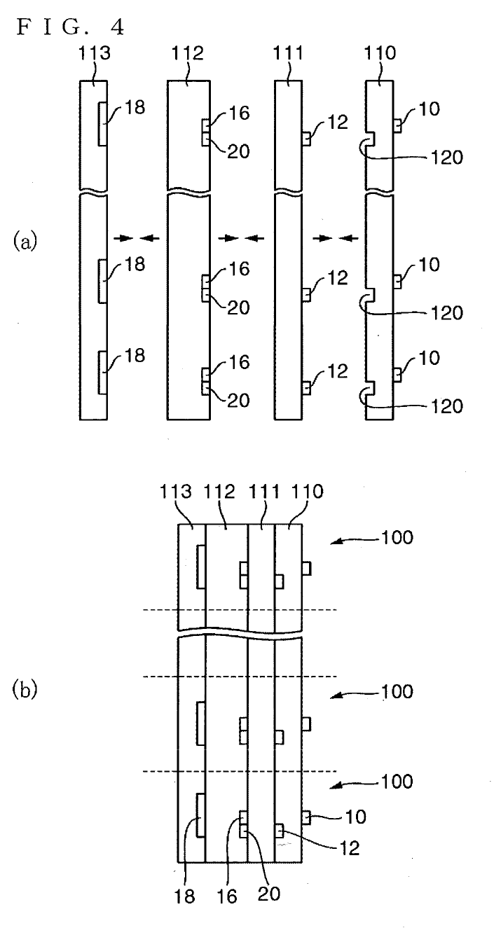

A detailed example of the method of manufacturing the optical transceiver 100 according to the present exemplary embodiment is described below. FIGS. 4(a) and 4(b) are schematics illustrating a method of manufacturing the optical transceiver 100 according to the present exemplary embodiment.

As shown in FIG. 4(a), a plurality of surface emitting lasers 10 are mounted on predetermined positions on one side of the transparent substrate 110. The other surface of the transparent substrate 110 is formed with recesses 120 at positions where the photo detectors 12 on the transparent substrate 111 abut when the transparent substrate 110 and the transparent substrate 111 are adhered later. Likewise, a plurality of photo detectors 12 are mounted on predetermined positions on one side of the transparent substrate 111. The transparent substrate 112 is formed with a plurality of diffraction gratings 16, 20 are formed on one side. The transparent substrate 113 is formed with a plurality of diffraction gratings 18 on one side.

As shown in FIG. 4(a), these transparent substrates 110-113 are adhered with each other. In this case, the transparent substrate 110 and the transparent substrate 111 are adhered so as to fit the photo detectors 12 into the recesses 120. Adhesion (mounting) of the transparent substrates 110-113 may be performed by various methods, such as bonding, fusion, contact bonding, fitting, clamping from both sides, and is not limited to a specific method.

As shown in FIG. 4(b), the adhered transparent substrates 110-113 are cut along predetermined position and divided into a plurality of sub-substrates, and then sleeves 22 (not shown in FIG. 4(b)) are mounted thereon, so that a plurality of optical transceivers 100 are manufactured.

According to the manufacturing method described above, since a number of patterns of the diffraction gratings can be formed simultaneously (during butch process) on one transparent substrate, the efficiency of the manufacturing process can be enhanced. Since the transparent substrate having a number of diffraction gratings mounted thereon and the transparent substrate having a number of surface emitting lasers or photo detectors are adhered with each other, and then divided into segments, a plurality of optical transceivers can be manufactured at once by only performing accurate alignment when adhering the transparent substrates. As a consequent, the number of times of alignment can significantly be reduced in comparison with the case in which individual optical transceiver is assembled separately, and thus the manufacturing process can be simplified.

Optical transceivers described below in conjunction with the second to the sixth exemplary embodiments may be manufactured in the same manner as described above.

(Second Exemplary Embodiment)

FIG. 5 is a schematic showing a construction of an optical transceiver according to the second exemplary embodiment. An optical transceiver 100a shown in FIG. 5 has a basically similar construction to the optical transceiver 100 described in the first exemplary embodiment, and the same parts are represented by the same reference numerals. The exemplary embodiments are different in that the diffraction grating 18 is replaced by a diffraction grating 18a, and in that a lens 19 is added. Focusing on the differences between them, the optical transceiver 100a according to the second exemplary embodiment will be described.

The diffraction grating 18a is formed on one side of a transparent substrate 113a, and changes the direction of the main beam of the incident beam coming from the diffraction grating 16 toward the substantially center of the opening of the sleeve 22.

The lens 19 is fitted into a groove, which is formed at a part of the transparent substrate 113a, and converges the beam coming from the diffraction grating 18a and enters it into the optical fiber 200 connected to the sleeve 22. In other words, the emitting beam from the optical fiber 200 is impinged onto the diffraction grating 18a as a substantially parallel ray via the lens 19.

The diffraction grating 18a, the lens 19, and the transparent substrates 112, 113a described above correspond to the wavelength-output angle transformational circuit as a spectroscopic unit.

In this manner, according to the second exemplary embodiment, since the lens 19 is disposed between the diffraction grating 18a and the sleeve 22, it is not necessary to provide a collective function to the diffraction grating 18a.

Therefore, the pattern of grating of the diffraction grating 18a can be formed as one-dimensional pattern, and thus intervals of the gratings can be increased, whereby fabrication of the diffraction grating 18a is advantageously facilitated.

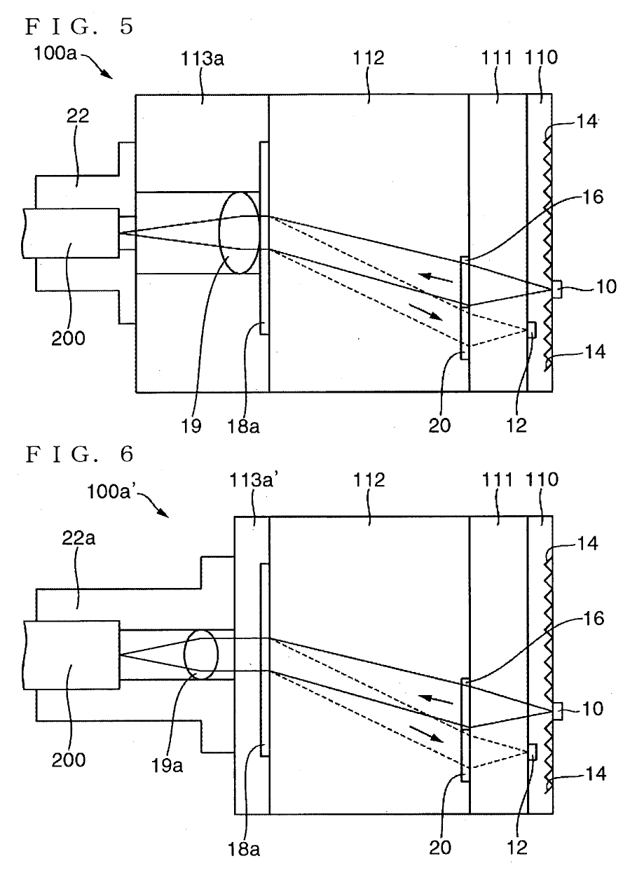

In the construction shown in FIG. 5, a groove is formed on the transparent substrate 113a and the lens 19 is fitted therein. However, a sleeve having a lens integrated therein may alternately be employed. FIG. 6 shows a construction of an optical transceiver employing a lens-integrated sleeve. An optical transceiver 100a′ shown in FIG. 6 has basically the same construction as the optical transceiver 100a shown in FIG. 5, and the same parts are represented by the same reference numerals.

As shown in FIG. 6, a sleeve 22a is a terminal to which one end of the optical fiber 200 is connected, and has a lens 19a integrated therein. The lens 19a converges a beam coming from the diffraction grating 18a provided on a transparent substrate 113a′, and enters it to the optical fiber 200 connected to the sleeve 22a. In other words, the emitting beam from the optical fiber 200 is impinged onto the diffraction grating 18a as a substantially parallel ray via the lens 19a. In this manner, the optical transceiver 100a′ having similar functions to the optical transceiver 100a shown in FIG. 5 can be realized by using the sleeve 22a integrated with the lens 19a.

(Third Exemplary Embodiment)

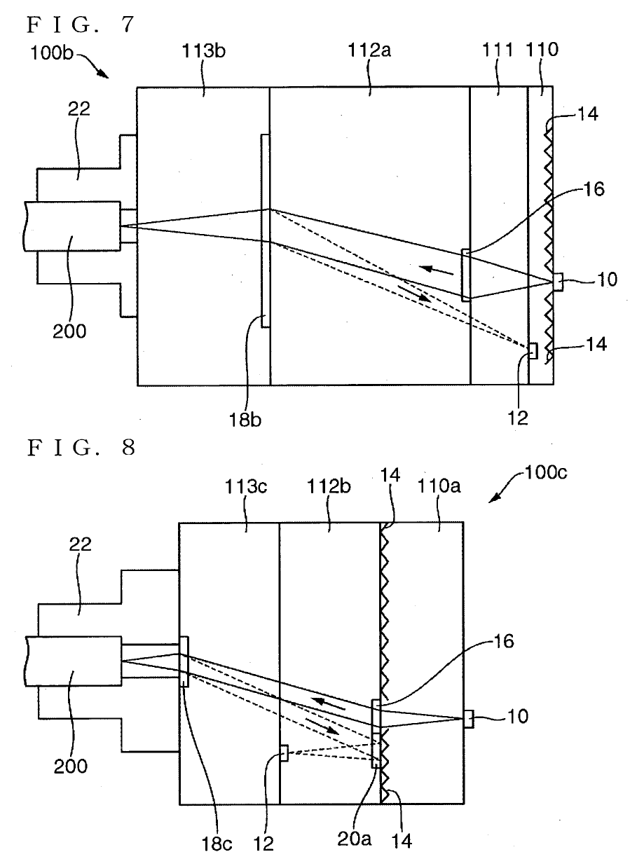

FIG. 7 is a schematic showing a construction of an optical transceiver according to the third exemplary embodiment. An optical transceiver 100b shown in FIG. 7 has a basically similar construction to the optical transceiver 100 described in conjunction with the first embodiment, and the same parts are designated by the same reference numerals. They are different in that the diffraction grating 18 is replaced by a diffraction grating 18b, and that the diffraction grating 20 is omitted. Focusing on the difference between them, the optical transceiver 100b according to the third exemplary embodiment will be described.

The diffraction grating 18b is formed on one side of the transparent substrate 113b, converges a signal beam having a wavelength of 1.55 μm, which is emitted from the optical fiber 200 connected to the sleeve 22, and changes the direction of the main beam into the direction toward the photo detector 12.

The diffraction grating 18b and the transparent substrates 112a, 113b described above correspond to the wavelength-output angle transformational circuit as a spectroscopic unit.

According to the third exemplary embodiment, as shown in FIG. 7, the transparent substrate 112a, which does not have the diffraction grating 20 described in the first exemplary embodiment is disposed between the transparent substrate 113b and the transparent substrate 111. The beam emitted from the diffraction grating 18b enters directly into the photo detector 12.

In this manner, according to the third exemplary embodiment, since additional diffraction grating is not disposed between the diffraction grating 18b and the photo detector 12 so that the beam from the diffraction grating 18b enters directly into the photo detector 12, loss of the intensity of the beam is reduced, and hence the intensity of beam entering into the photo detector 12 can be increased. Consequently, the quality of the received signal can advantageously be increased.

(Fourth Exemplary Embodiment)

FIG. 8 is a schematic showing a construction of an optical transceiver according to the fourth exemplary embodiment. An optical transceiver 100c shown in FIG. 8 has a basically similar construction to the optical transceiver 100 described in the first exemplary embodiment, and the same parts are represented by the same reference numerals. Focusing on the difference between them, the optical transceiver 100c according to the fourth exemplary embodiment is described below.

The optical transceiver 100c of the fourth exemplary embodiment includes a transparent substrate 110a formed with the surface emitting laser 10 and the metallic film 14, a transparent substrate 112b formed with the diffraction grating 16 and a reflecting type diffraction grating 20a, and a transparent substrate 113c formed with a diffraction grating 18c adhered with each other in layers.

The surface emitting laser 10 is mounted on one surface of the transparent substrate 110a. The metallic film 14 is formed on the other surface (the surface to be abutted against the transparent substrate 112b) of the transparent substrate 110a. The metallic film 14 is arranged between the surface emitting laser 10 and the photo detector 12 and serves to prevent or reduce cross-talk between them, and as in the case of the first exemplary embodiment, is formed by forming a metallic thin film on the other side of the transparent substrate 110a.

The diffraction grating 18c is formed on one side of the transparent substrate 113c, converts a signal beam having a wavelength of 1.55 μm emitted from the optical fiber 200 connected to the sleeve 22 into a parallel ray, and changes the direction of the main beam into the direction toward the diffraction grating 20a. The diffraction grating 18c changes the direction of the main beam of the beam coming from the diffraction grating 16 toward the sleeve 22, converges it, and enters the beam into the optical fiber 200 connected to the sleeve 22. The photo detector 12 is mounted on the other surface of the transparent substrate 113c.

The diffracting grating 18c and the transparent substrates 112b and 113c described above correspond to the wavelength-output angle transformational circuit as a spectroscopic unit.

The reflecting type diffracting grating 20a is formed on one side (on the same surface as the surface on which the diffraction grating 16 is formed) of the transparent substrate 112b, reflects and converges the beam emitted from the diffraction grating 18c, and introduces the converged beam into the photo detector 12. As shown in FIG. 8, the optical transceiver 100c according to the fourth exemplary embodiment, the photo detector 12 is mounted on the other side (the surface abutting against the transparent substrate 112b) of the transparent substrate 113c, so that the beam reflected and converted by the diffraction grating 20a enters into the photo detector 12. It is also possible to use the metallic film 14 as a reflecting film of the reflecting type diffraction grating 20a.

In this manner, according to the fourth exemplary embodiment, the signal beam emitted from the optical fiber 200 and introduced to the diffraction grating 20a by the diffraction grating 18c is converged while being reflected toward the opposite direction by the diffraction grating 20a, and is received by the photo detector 12. Therefore, the photo detector 12 may be arranged at the position significantly away from the surface emitting laser 10. Consequently, the cross-talk between a transmitting unit including the surface-emission laser 10 and a receiving unit including the photo detector 12 can be prevented or reduced.

(Fifth Exemplary Embodiment)

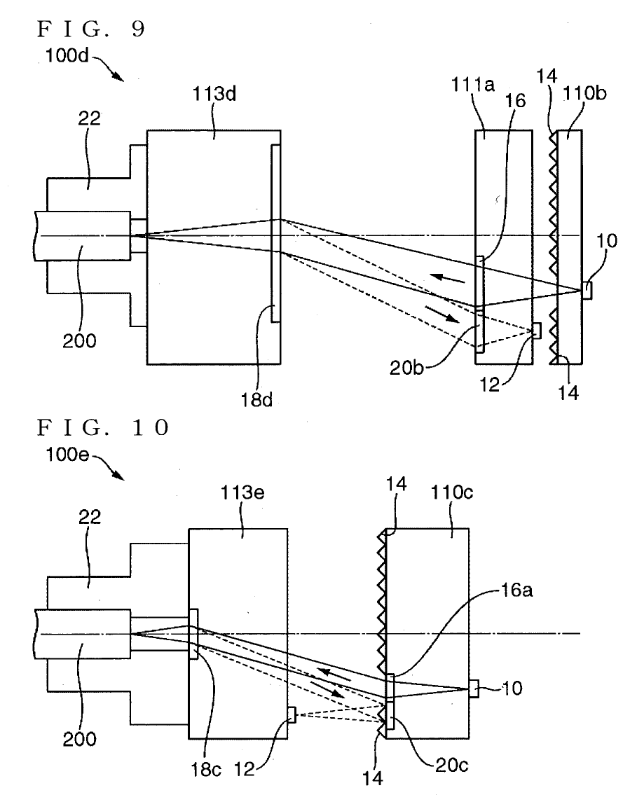

FIG. 9 is a schematic showing a construction of an optical transceiver according to the fifth exemplary embodiment. An optical transmitter 100d shown in FIG. 9 has a basically similar construction to the optical transceiver 100 described in the first exemplary embodiment, and the same parts are designated by the same reference numerals. Focusing on the difference between them, the optical transceiver 100d according to the fifth exemplary embodiment is described below.

The optical transceiver 100d of the fifth exemplary embodiment includes a transparent substrate 110b formed with the surface emitting laser 10 and the metallic film 14, a transparent substrate 111a formed with the diffraction grating 16 and an diffraction grating 20b and having the photo detector 12 mounted thereon, an a transparent substrate 113d formed with a diffraction grating 18d adhered in layers. In the present exemplary embodiment, the transparent substrate 110b and the transparent substrate 111a, and the transparent substrate 111a and the transparent substrate 113d are adhered respectively with each other with a spacer or the like (not shown) being interposed therebetween, so that a predetermined distance is secured from each other. The reason why a predetermined distance is secured between the transparent substrates in this manner is described below.

The surface emitting laser 10 is mounted on one side of the transparent substrate 110b. The metallic film 14 is formed on the other side of the transparent substrate 110b. The metallic film 14 is arranged between the surface emitting laser 10 and the photo detector 12 to prevent or reduce the cross-talk between them, and formed by forming the metallic thin film on the other side of the transparent substrate 110b as in the case of the first exemplary embodiment described above.

The diffraction grating 18d has a similar function to the diffraction grating 18 included in the optical transceiver 100 according to the first exemplary embodiment, and formed on one side of the transparent substrates 113d. The diffraction grating 18d employed in this exemplary embodiment is a relief type diffraction grating, which causes diffraction of a beam utilizing the difference of refractive index between the material constructing the diffraction grating 18d and air in contact with the diffraction grating 18d . Therefore, in the optical transceiver 100d of the present exemplary embodiment, as described above, a predetermined distance is secured between the transparent substrate 111b and the transparent substrate 113d to form an air layer between the transparent substrates.

The diffraction grating 20b has a similar function to the diffraction grating 20 included in the optical transceiver 100 of the first exemplary embodiment, and formed on one side (the same surface on which the diffraction grating 16 is formed) of the transparent substrate 111a. In the present exemplary embodiment, the diffraction grating 20b employed here is also the same relief type diffraction-grating as the diffraction grating 18d. Therefore, in the optical transceiver 100d of the present exemplary embodiment, a predetermined distance is secured between the transparent substrate 110b and the transparent substrate 111a to form an air layer between the transparent substrates, as described above.

The diffraction grating 18d and the transparent substrate 113b described above correspond to the wavelength-output angle transformational circuit as a spectroscopic unit.

In this manner, even when the relief type diffraction gratings 18d, 20b are used, the optical transceiver 100d having a similar function to the optical transceiver 100 shown in FIG. 1 can be realized.

(Sixth Exemplary Embodiment)

FIG. 10 is a schematic showing a construction of an optical transceiver according to the sixth exemplary embodiment. An optical transceiver 100e shown in FIG. 10 has a basically similar construction to the optical transceiver 100c described in the fourth exemplary embodiment shown in FIG. 8, and the same parts are represented by the same reference numerals. Focusing mainly on the difference between them, the optical transceiver 100e according to the sixth exemplary embodiment is described below.

The optical transceiver 100e of the sixth exemplary embodiment includes a transparent substrate 110c formed with the surface emitting laser 10, the metallic film 14, a diffraction grating 16a, and a reflecting type diffraction grating 20c, and a transparent substrate 113e formed with the photo detector 12 and the diffraction grating 18c adhered with each other into layers.

The diffraction grating 16a has a similar function to the diffraction grating 16 included in the optical transceiver 100c according to the fourth exemplary embodiment. Simultaneously, the diffraction grating 20c has a similar function to the diffraction grating 20a included in the optical transceiver 100c according to the fourth exemplary embodiment. In the present exemplary embodiment, a relief-type diffraction grating is employed as the diffraction grating 16a and the diffraction grating 20c. Therefore, the transparent substrate 110c and the transparent substrate 113e are adhered with a spacer (not shown) or the like being interposed therebetween for securing a predetermined distance and forming an air layer between the transparent substrates.

The diffraction grating 18c and the transparent substrate 113e described above correspond to the wavelength-output angle transformational circuit as a spectroscopic unit.

As described above, even when the relief type diffraction gratings 16a, 20a are employed, the optical transceiver 100e having a similar function to the optical transceiver 100c of the fourth exemplary embodiment shown in FIG. 8 is achieved.

The present invention is not limited to the above-described exemplary embodiments, and may be modified in various ways and remain within the scope of the present invention. For example, although the diffraction grating is used as a spectroscopic unit in the exemplary embodiments described above, other angular dispersion elements, such as a prism, may be employed. Although the diffraction grating is used as the first deflection unit or the second deflection unit in the exemplary embodiments described above, a refracting element, such as a lens, may be employed.

Although the beam emitted from the optical fiber 200 is impinged onto the transparent substrate at a substantially right angle in the exemplary embodiments described above, the beam, which is changed in direction by a mirror or the like as required, may be impinged onto the accumulated transparent substrates. Although the wavelengths of the signal beam employed are 1.3 μm and 1.55 μm in the description of the exemplary embodiments, the wavelength of the signal light is not limited thereto.

As described thus far, according to the present invention, the construction is simplified and the alignment is facilitated by disposing the elements, such as the spectroscopic unit, the light emitter, and the light receiver, on a surface perpendicular to the optical axis of the signal beam emitted from one end of the optical path, and thus the manufacturing process of the optical transceiver can be simplified. As a consequence, the manufacturing costs can be reduced, and the optical transceiver can be provided at lower costs.

According to the manufacturing method according to the present invention, since the optical transceiver is manufactured by forming the transparent substrates formed with a number of elements, such as the spectroscopic unit or the like into layers, and then dividing them into segments, a plurality of optical transceivers can be manufactured at once without performing alignment individually for each optical transceiver only by performing accurate alignment when assembling the transparent substrates. Therefore, the number of times of alignment can be reduced significantly and the reduction of the manufacturing cost is achieved by simplifying the manufacturing processes.

What is claimed is:

1. An optical transceiver, comprising:
a spectroscopic unit;
a light emitter; and
a light receiver, the spectroscopic unit, the light emitter, and the light receiver being disposed at one end of an optical path to propagate a signal beam in both directions, and being disposed respectively on a surface substantially orthogonal to the optical axis of the signal beam emitted from one end of the optical signal path;
the spectroscopic unit changing the direction of the signal beam emitted from one end of the optical path and introducing toward the light receiver, and the spectroscopic unit introducing the signal beam emitted from the light emitter to one end of the optical path.

2. An optical transceiver, comprising:
a spectroscopic unit;
a light emitter; and
a light receiver, the spectroscopic unit, the light emitter, and the light receiver being disposed at one end of an optical path to propagate a plurality of signal beams having different wavelengths in both directions, and being disposed respectively on a surface substantially orthogonal to the optical axis of the signal beam emitted from one end of the optical signal path;
the spectroscopic unit receiving the signal beam emitted from one end of the optical path as an incident beam, converting the direction of the optical axis of the incident beam corresponding to the wavelength thereof, and introducing to the light receiver; and
the spectroscopic unit introducing the signal beam emitted from the light emitter to one end of the optical path as an emitting beam.

3. The optical transceiver according to claim 1, the spectroscopic unit, the light emitter, and the light receiver being located at different orthogonal surfaces respectively.

4. The optical transceiver according to claim 1, the spectroscopic unit, the light emitter, and the light receiver being supported by transparent substrates respectively.

5. The optical transceiver according to claim 1, the spectroscopic unit being an wavelength-output angle transformational circuit to vary the angle of the optical axis of the emitting beam corresponding to the wavelength of an incident beam, including a diffraction grating.

6. The optical transceiver according to claim 5, a thickness d of the grating being set to a value satisfying the expression λ1/(n−1)<d<λ2/(n−1),
where d represents the thickness of the diffraction grating, n represents an index of refraction of the material of the diffraction grating, λ1 represents the smaller one of the wavelengths of the emitting beam and the incident beam, and λ2 represents the larger one of the wavelengths of the emitting beam and the incident beam.

7. The optical transceiver according to claim 5, the diffraction grating having a conversing function.

8. The optical transceiver according to claim 1, the spectroscopic unit being the wavelength-output angle transformational circuit to change the angle of the optical axis of the emitting beam corresponding to the wavelength of the incident beam, including a prism.

9. The optical transceiver according to claim 1, further comprising a first deflecting unit to convert the direction of the signal beam emitted from the light emitter and guide the beam to the spectroscopic unit.

10. The optical transceiver according to claim 9, the first deflecting unit being the wavelength-output angle transformational circuit to vary the angle of the optical axis of the emitting beam corresponding to the wavelength of the incident beam including the diffraction grating.

11. The optical transceiver according to claim 9, the first deflecting unit being disposed on a surface, which is substantially parallel with a plane, on which the spectroscopic unit is disposed.

12. The optical transceiver according to claim 9, further comprising a second deflecting unit to convert the direction of the signal beam emitted from the spectroscopic unit and introduce the beam to the light receiver.

13. The optical transceiver according to claim 12, the second deflecting unit being the wavelength-output angle transformational circuit to vary the angle of the optical axis of the emitting beam corresponding to the wavelength of the incident beam, including the different grating or a lens.

14. The optical transceiver according to claim 12, the second deflecting unit further including a collective function.

15. The optical transceiver according to claim 12, the second deflecting unit being disposed in a surface, which is substantially parallel with the surface on which the spectroscopic unit is disposed.

16. The optical transceiver according to claim 12, the first and second deflecting units being arranged on the same plane.

17. The optical transceiver according to claim 12, the second deflecting unit being a reflecting type diffraction grating, which reflects the signal beam emitted from the spectroscopic unit and introduces the beam to the light receiver.

18. The optical transceiver according to claim 1, further comprising a light conversing unit to guide the signal beam emitted from one end of the optical path to the spectroscopic unit as a substantially parallel ray.

19. The optical transceiver according to claim 1, further comprising a cross-talk preventing unit disposed between the light emitter and the light receiver to prevent leakage of signals from therebetween.

20. A method of manufacturing an optical transceiver that includes a light emitter, a light receiver, and a spectroscopic unit to change the direction of the optical axis of an emitting beam corresponding to the wavelength of an incident beam, the optical transceiver being arranged at one end of the optical signal path, which is used to propagate a plurality of signal beams having different wavelengths in both directions, to transmit and receive information, the method comprising:
assembling a first transparent substrate formed with the plurality of spectroscopic units, a second transparent substrate formed with a plurality of light receivers, and a third transparent substrate formed with the plurality of light emitters assembled in layers; and
cutting the assembled first to third transparent substrates into a plurality of sub-substrates that each include one of the light receiver, the light emitter, and the spectroscopic unit.

21. The method of manufacturing an optical transceiver according to claim 20, the spectroscopic unit formed on the first transparent substrate being the diffraction grating.
